(19) United States
(12) Patent Application Publication
(10) Pub. No.: US 2012/0112388 A1
(43) Pub. Date: May 10, 2012

(54) MANUFACTURING METHOD OF HYDROPHOBIC AEROGEL AND ITS MANUFACTURING APPARATUS

(76) Inventor: Young-Il Kim, Kangwon-do (KR)

(21) Appl. No.: 13/383,720

(22) PCT Filed: Jul. 13, 2010
(86) PCT No.: PCT/KR2010/004545

§ 371 Date: Jan. 12, 2012

(30) Foreign Application Priority Data
Jul. 13, 2009 (KR) 10-2009-0063749

(51) Int. Cl. B29C 67/20; C01B 33/152

(52) U.S. Cl. 264/419; 425/4 R

(57) ABSTRACT

A method of manufacturing a hydrophobic aerogel using a process of reforming a wet gel into a hydrophobic aerogel by a generally known normal temperature and pressure method, including: directly providing a reticular basket in a reactor; introducing a wet gel into the basket; providing an ultrasonic generator under the reactor to emit ultrasonic waves; and providing a nitrogen injection unit under the ultrasonic generator to inject nitrogen into the reactor upwards, thereby accelerating a reaction. An apparatus for manufacturing a hydrophobic aerogel, including: a reactor for reforming a wet gel into a hydrophobic gel, the reactor being provided therein with a support to allow a basket to be disposed therein, an ultrasonic generator which is provided under the reactor; and a nitrogen injection unit which is provided under the ultrasonic generator.

### TECHNICAL FIELD

The present invention relates to a method and apparatus for manufacturing a hydrophobic aerogel, and, more particularly, to a method and apparatus for manufacturing a hydrophobic aerogel, which can manufacture a hydrophobic aerogel in a short period of time to improve economic efficiency.

### BACKGROUND ART

An aerogel is a transparent ultralow-density advanced material having a porosity of 90% or more and a specific surface area of several hundreds to 1500 m²/g. Such a porous aerogel can be practically used in ultralow dielectrics, catalysts, electrode materials, soundproofing materials, and the like. In particular, a silica aerogel is a thermal insulating material which has high potentiality as a transparent insulating material and which can be very effectively used in refrigerators, automobiles, airplanes, etc., because it has high light transmittance and low thermal conductivity.

As such, since aerogels can be practically used in various industrial fields, advanced aerogels are attracting considerable attention all over the world. However, several problems must be solved in order for aerogels to be successfully commercialized.

First, in order to make aerogel commercially available, a method of eternally preventing an aerogel from absorbing moisture in the air is required because the gel characteristics and physical properties of an aerogel become poor when an aerogel absorbs moisture. Different research has been conducted into this, and, as a result, various methods for manufacturing an eternally-hydrophobic aerogel by hydrophobizing the surface of aerogel have been proposed.

For example, WO 96/22942 discloses a method of manufacturing a hydrophobic aerogel, wherein a silicate lyogel is solvent-substituted with an organic solvent (methanol, ethanol, propanol, acetone, tetrahydrofuran or the like), reacted with a silylizing agent containing no chlorine, and then supercritical-dried to form a hydrophobic aerogel. WO 98/23367 also discloses a method of manufacturing a hydrophobic aerosol, wherein a lyogel formed by reacting water glass with acid is solvent-substituted with an organic solvent (methanol, ethanol, acetone, ketone or the like) such that the amount of water in the lyogel is 5 wt % or less, silylized and then dried to form a hydrophobic aerogel.

Further, WO97/17288 discloses a method of manufacturing a hydrophobic aerogel, wherein a silica sol having a pH of 4 or less is formed from a water glass solution using organic and/or inorganic acid, salts formed from acids and cations of water glass are separated from the silica sol at 0˜30° C., a base is added to the silica sol to polycondense the silica sol into a silica (SiO₂) gel, and then the silica gel is solvent-substituted with an organic solvent (aliphatic alcohols, ethers, esters, ketones, aliphatic or aromatic hydrocarbons or the like), silylized and then dried to manufacture a hydrophobic aerogel. WO 98/23366 discloses a method of manufacturing a hydrophobic aerogel without solvent substitution, wherein a hydrogel is formed in a pH of 3 or more and then intermediate-processed, and then the hydrogel is mixed with a hydrophobizing agent to change the surface thereof, and then, if necessary, the hydrogel is washed with a protonic or nonprotonic solvent (aliphatic alcohols, ethers, esters, ketones, aliphatic or aromatic hydrocarbons or the like), silylized and then dried to manufacture a hydrophobic aerogel.

However, conventional methods of manufacturing a hydrophobic aerogel are problematic in that it takes a lot of time to conduct solvent substitution, thus increasing the manufacturing cost thereof, and in that a large amount of hydrophobic aerogel cannot be produced.

### DISCLOSURE

### Technical Problem

Accordingly, an object of the present invention is to provide a method of manufacturing a hydrophobic aerogel, which can reduce the manufacturing cost by minimizing the time it takes to conduct solvent change and can easily produce a hydrophobic aerogel in large quantity.

Another object of the present invention is to provide an apparatus for easily manufacturing a hydrophobic aerogel.

### Technical Solution

In order to accomplish the above objects, an aspect of the present invention provides a method of manufacturing a hydrophobic aerogel using a process of reforming a wet gel into a hydrophobic aerogel by a generally known normal temperature and pressure method, including: directly providing a reticular basket in a reactor; introducing a wet gel into the basket; providing an ultrasonic generator under the reactor to emit ultrasonic waves; and providing a nitrogen injection unit under the ultrasonic generator to inject nitrogen into the reactor upwards, thereby accelerating a reaction.

Another aspect of the present invention provides an apparatus for manufacturing a hydrophobic aerogel, including: a reactor for reforming a wet gel into a hydrophobic gel, the reactor being provided therein with a support to allow a basket to be disposed therein, an ultrasonic generator which is provided under the reactor; and a nitrogen injection unit which is provided under the ultrasonic generator. The method and apparatus for manufacturing a hydrophobic aerogel is advantageous in that the hydrophobic aerogel can be manufactured in a short period of time, thus improving economic efficiency.

The method and apparatus for manufacturing a hydrophobic aerogel is advantageous in that the hydrophobic aerogel can be manufactured in a short period of time, thus improving economic efficiency.

### Advantageous Effects

The method and apparatus for manufacturing a hydrophobic aerogel according to the present invention is advantageous in that, in a process of reforming a wet gel into a hydrophobic aerogel at normal temperature and pressure using a generally known method, a solvent exchange reaction is accelerated, so that the manufacturing cost thereof can be reduced, and a hydrophobic aerogel can be easily produced in large quantity.

### DESCRIPTION OF DRAWINGS

FIG. 1 is a schematic view showing a process of manufacturing a hydrophobic aerogel;

FIG. 2 is a schematic view showing an apparatus for manufacturing a hydrophobic aerogel according to an embodiment of the present invention;

FIG. 3 is a schematic view showing an apparatus for manufacturing a hydrophobic aerogel, in which two reactors are connected with one storage tank, according to another embodiment of the present invention;

FIG. 4 shows photographs verifying the hydrophobization of pearlite;

FIG. 5 shows photographs verifying the hydrophobization of silica gel; and

FIG. 6 shows photographs verifying the hydrophobization of hydrogel.

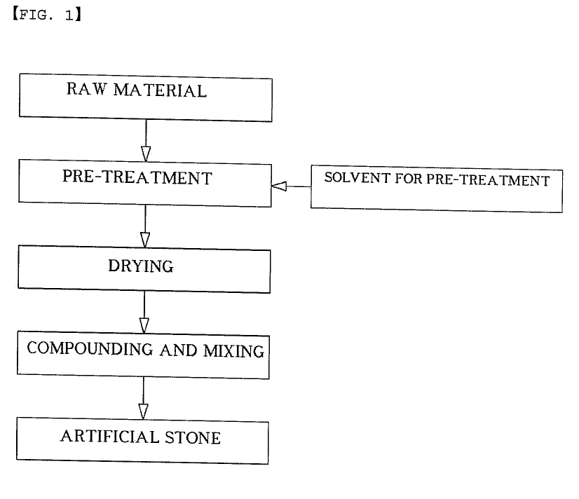

### DESCRIPTION OF THE REFERENCE NUMERALS IN THE DRAWINGS

100: reactor
101: support
110: basket
130: ultrasonic generator
130: nitrogen injection unit
140: condenser

### BEST MODE

The method of manufacturing a hydrophobic aerogel according to the present invention is characterized in that, in a process of reforming a wet gel into a hydrophobic aerogel at normal temperature and pressure using a generally known method, a reticular basket is directly provided in a reactor, a wet gel is introduced into the basket, an ultrasonic generator is provided under the reactor to emit ultrasonic waves, and a nitrogen injection unit is provided under the ultrasonic generator to inject nitrogen into the reactor upwards, thereby accelerating a reaction.

Further, the apparatus for manufacturing a hydrophobic aerogel according to the present invention is characterized in that, in a reactor 100 for reforming a wet gel into a hydrophobic gel, the reactor 100 is provided therein with a support 101 to allow a basket 110 to be disposed therein, an ultrasonic generator 120 is provided under the reactor 100, and a nitrogen injection unit 130 is provided under the ultrasonic generator 120.

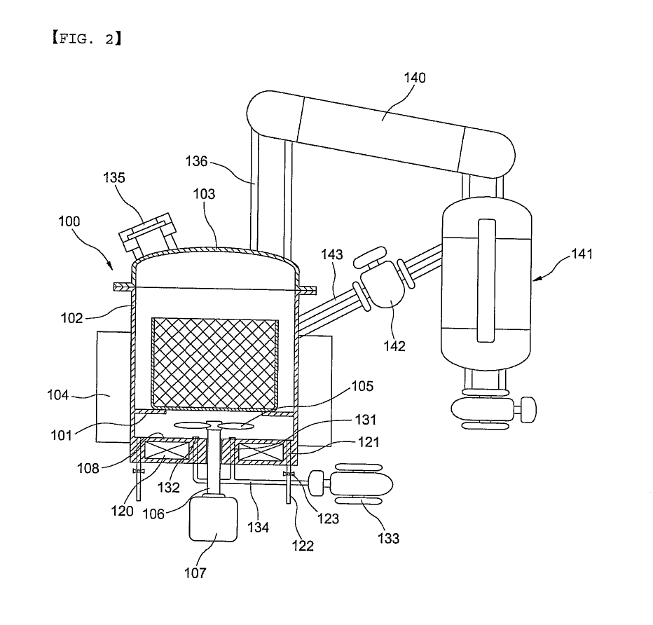

As shown in FIG. 2, the reactor 100 includes a body 102 and a cover 103, and the body 102 and the cover 103 are strongly coupled together by commonly-known coupling means (not shown). The body 102 of the reactor 100 is mounted at the periphery thereof with a heating unit 104. A rotary shaft 100, one end of which is connected to a motor 107 and the other end of which is connected to a stirrer 105, is inserted into the body 102 of the reactor 100. The body 102 is provided at the lower portion thereof with a partition wall 108, and a compartment formed by the partition wall 108 is embedded with an ultrasonic generator 120.

Further, the reactor 100 is provided with at least one drain outlet 121 for draining water from the reactor 100. Each drain pipe 122 protruding out of the reactor 100 is transparent such that it can be observed with the naked eyes, and is provided with a control valve 123.

Furthermore, the nitrogen injection unit 130, serving to supply nitrogen into the reactor 100, includes at least one blowing inlet 131, a check valve 132 provided at the end of the blowing inlet 131, a blower 133, and a blowing pipe 134 for connecting the blowing inlet 131 with the blower 133. A nitrogen tank (not shown) may be connected to the nitrogen injection unit 130.

Meanwhile, the cover 103 of the reactor 100 is provided with a window 135 through which a reaction state is observed and a distillation tube 136 through which a solvent is vaporized. The distillation tube 136 is connected with a condenser 140, and the condenser 140 is connected with a refrigerator (not shown). Further, the condenser 140 is connected with a storage tank 141, and the storage tank 141 is connected with the reactor 100 by a supply pipe 143 provided with a switching valve 142.

The above-mentioned apparatus for manufacturing a hydrophobic aerogel according to the present invention, as shown in FIG. 3, may be configured such that one storage tank 141 is connected with two or more reactors 100, and may be configured such that one condenser 140 and one storage tank 141 are connected with two or more reactors 100.

In the hydrophobization of an aerogel using the apparatus for manufacturing a hydrophobic aerogel according to the present invention, first, a nonpolar solvent, which is not mixed with water while forming a layer, must be selected.

Preferably, examples of the nonpolar solvent may include n-butanol, n-pentanol, n-hexane, etc. Subsequently, when a silane compound is added to a raw material (wet gel) in an amount of 5˜10% based on the amount of the raw material, the silane compound reacts with a hydroxy group of the raw material to provide eternal hydrophobicity. In this case, the silane compound is represented by Chemical Formula: R₄-n-SiXₙ (here, n is an integer of 1˜3; R₄ is an alkyl group, aromatic alkyl group or heteroaromatic alkyl group of C₁-C₁₀, preferably C₁-C₅, or hydrogen; and X is a halogen selected from F, Cl, Br and I, preferably Cl or an alkoxy group, alkyl group, aromatic alkyl group or heteroaromatic alkyl group of C₁-C₁₀, preferably C₁-C₅). Further, a disiloxane compound is used as a silylizing agent. The disiloxane compound is represented by Chemical Formula: R₃Si—O—SiR₃ (here, each R₃ is independently an alkyl group, aromatic alkyl group or heteroaromatic alkyl group of C₁-C₁₀, preferably C₁-C₅, or hydrogen). Specific examples of the disiloxane compound may include, but are not limited to, methyltrimethoxysilane, ethyltrimethoxysilane, hexamethyldisilane, trimethylchlorosilane, and triethylethoxysilane.

In order to remove impurities from a mixed solvent of the selected solvent and silylizing agent and to easily hydrolyze the silylizing agent, a raw material clearly washed with water is immersed in the mixed solvent and then refluxed to completely remove water from the raw material. It is effective when the reflux temperature is close to the boiling point of the solvent. The vaporized solvent is condensed in a cooling pipe again, and is then refluxed until water is completely removed therefrom.

That is, when the selected solvent, silylizing agent and raw material are introduced into the reactor 100, and are then heated to about the boiling point of the selected solvent using the heating unit 104 and simultaneously stirred using the stirrer 105, the raw material is hydrophobized by the hydrolysis of the silylizing agent and the reaction of the raw material, and the solvent is vaporized, and water moves downwards.

The vaporized solvent is converted into liquid by the condenser 140, transferred to the storage tank 141 and then returned to the reactor 100 by the supply pipe 143 provided with the switching valve 142, and water is discharged to the outside through the drain outlet 121 and drain pipe 122 provided under the reactor 100.

In the present invention, the raw material is charged in the basket 110, introduced into the reaction to cause a reaction, and then rapidly transferred to a drying chamber. In this case, in order that the basket 110 does not hinder the operation of the stirrer 105, a support 101 is provided in the reactor 100, and thus the basket 110 is disposed on the support 101 to provide the basket 110 in the reactor 100.

In order to accomplish the hydrophobization (the removal of moisture) in a short period of time, the inside of the reactor 100 is irradiated with ultrasonic waves by the ultrasonic generator 120. In order to provide the ultrasonic generator 120 in the reactor 100, the body 102 of the reactor 100 is provided at the lower portion thereof with a partition wall 108, and a compartment formed by the partition wall 108 is embedded with the ultrasonic generator 120. In this case, the partition wall 108 may be made of a material having strong solvent resistance, and may have a thickness of 3 mm or less. The material and thickness of the partition wall 108 may be appropriately changed in consideration of such conditions as ultrasonic wave transfer, pressure in the reactor 108, and the like.

Moreover, when air bubbles are generated in the reactor 100 at a rate of 3˜5 l/min using the nitrogen injection unit 130, moisture is removed remarkably rapidly. In order to supply air bubbles into the reactor 100 using nitrogen, the nitrogen injection unit 130 includes at least one blowing inlet 131, a check valve 132 provided at the end of the blowing inlet 131, a blower 133, and a blowing pipe 134 for connecting the blowing inlet 131 with the blower 133. A nitrogen tank (not shown) may be connected to the nitrogen injection unit 130.

As described above, when the inside of the reactor 100 is irradiated with ultrasonic waves and air bubbles are supplied into the reactor 100 using nitrogen, moisture is removed remarkably rapidly, and the hydrophobization of an aerogel is completed in a very short period of time, thus cheaply manufacturing a hydrophobic aerogel.

The irradiation of ultrasonic waves serves to improve reactivity by atomizing a cluster of water molecules into 5˜6 water molecules, and the generation of air bubbles serves to accelerate the hydrophobization of the aerogel.

When the hydrophobization is completed, the raw material is transferred to a general dryer and then dried to manufacture a hydrophobic aerogel. The raw material is dried using hot air at a drying temperature of 100˜150° C. When the drying temperature is lower than 100° C., drying speed is excessively slow, and when the drying temperature is higher than 150° C., the hydrophobized silane group is damaged by thermal decomposition.

The surface of the manufactured hydrophobic aerogel is irreversibly imparted with hydrophobicity such that the moisture resistance thereof is near 0. Further, the porosity and thermal conductivity thereof is greatly improved.

In the apparatus for manufacturing a hydrophobic aerogel according to the present invention, it is more effective for the heating unit 104 to have a cooling function as well as a heating function such that the reactor 100 can be heated and cooled. That is, since the reactor 100 must be cooled to room temperature at the time of introducing and recovering the raw material, when the heating unit has a cooling function, the reactor 100 is rapidly cooled, thus shortening the time taken to manufacture a hydrophobic aerogel.

Further, since the basket 110 has a reticular structure, it easily makes contact with a solvent and a silylizing agent, and water is easily discharged therefrom. Further, since the blowing inlet 131 is provided at the end thereof with the check valve 132, it is possible to prevent water from being introduced into the nitrogen injection unit 130.

Furthermore, a controller (not shown) may be provided in order to control the temperature of the heating unit, the injection pressure and injection rate of nitrogen gas and the amount of the solvent reintroduced from the storage tank 141, and various sensors may be provided in order to perform an automatic operation.

### MODE FOR INVENTION

Hereinafter, the present invention will be described in more detail with reference to the following Examples. However, the scope of the present invention is not limited to these Examples.

### Example 1

100 g of pearlite and 100 g of fine silica powder were respectively washed with clean water several times to remove impurities therefrom, and were then charged in a basket 110. Subsequently, the basket 110 charged with the washed pearlite and fine silica powder was put into a reactor 100, and then 1 l of n-butanol, as a solvent, and 5 g of methyltrimethoxysilane (MMTS), as a silylizing agent, were added thereto.

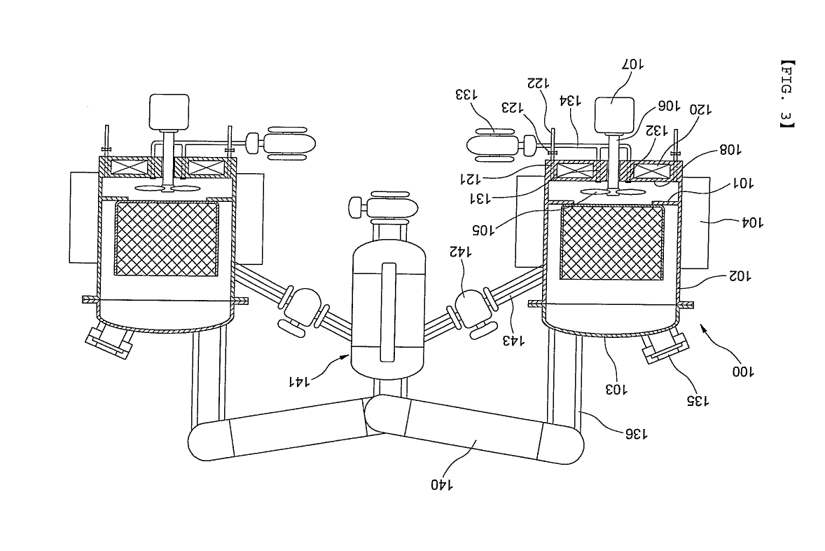

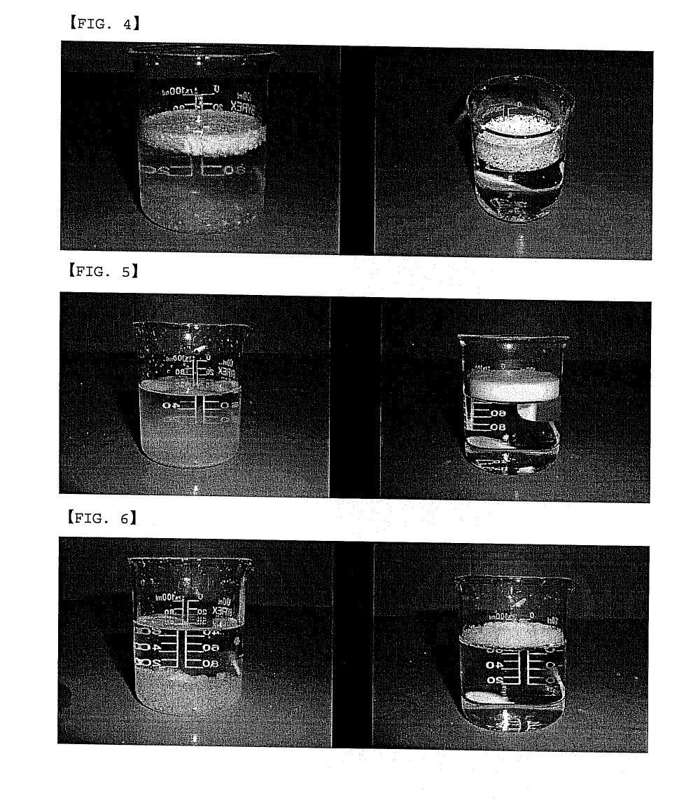

Thereafter, the temperature of the reactor 100 was adjusted to 110° C., ultrasonic waves of 4˜14 μm were irradiated, and air bubbles were generated at a rate of 3˜5 l/min. N-butanol was refluxed until moisture was completely removed in such a manner that water was removed by a condenser, water was removed from n-butanol, and n-butanol was returned to the reactor 100. After 6 hours, moisture was completely removed from the solvent, and pearlite and silica fine powder were separated from the solvent and then dried at 110° C. The physical properties of the pearlite and fine silica powder treated in this way were measured and evaluated, and the results thereof are given in Table 1 below. In order to ascertain whether or not the treated pearlite and silica fine powder were hydrophobized, untreated pearlite, untreated fine silica powder, the treated pearlite and the treated fine silica powder were respectively dissolved in water. After 12 hours, photographs thereof were taken, and were then shown in FIG. 4 (left: untreated pearlite, right: treated pearlite) and FIG. 5 (left: untreated fine silica powder, right: treated fine silica powder).

TABLE 1

| | Pearlite | | Fine silica powder | |
|---|---|---|---|---|
| | before | after | before | after |
| | reaction | reaction | reaction | reaction |
| Thermal | 90~95 | 45~50 | 90~100 | 30~40 |
| conductivity | | | | |
| (mW/mK) | | | | |
| Porosity (%) | 5~10 | 60~70 | 5~10 | 60~70 |
| Hyphobized | little | full | none | full |

As shown in Table 1 and FIGS. 4 and 5, it can be seen that the hydrophobicity of the pearlite and silica fine powder treated in Example 1 is excellent.

### Example 2

1 l of hydrogel (silica wet gel) was washed with clean water several times to remove impurities therefrom, and was then charged in a basket 110. Subsequently, the basket 110 charged with the washed hydrogel was put into a reactor 100, and then 1 l of n-butanol, as a solvent, and 5 g of methyltrimethoxysilane (MMTS), as a silylizing agent, were added thereto.

Thereafter, the temperature of the reactor 100 was adjusted to 110° C., ultrasonic waves of 4˜14 μm were irradiated, and air bubbles were generated at a rate of 3˜5 l/min. N-butanol was refluxed until moisture was completely removed in such a manner that water was removed by a condenser, water was removed from n-butanol, and n-butanol was returned to the reactor 100. After 6 hours, moisture was completely removed from the solvent, and hydrogel was separated from the solvent and then dried at 110° C. The physical properties of the hydrogel treated in this way were measured and evaluated, and the results thereof are given in Table 2 below. In order to ascertain whether or not the treated hydrogel was hydrophobized, untreated hydrogel and the treated hydrogel were respectively dissolved in water. After 12 hours, photographs thereof were taken, and were then shown in FIG. 6 (left: untreated hydrogel, right: treated hydrogel).

TABLE 2

| | Pearlite | |
|---|---|---|
| | before reaction | after reaction |
| Thermal conductivity | 90~100 | 10~15 |
| (mW/mK) | | |
| Porosity (%) | 5~10 | 60~70 |
| Hyphobized | little | full |

1. A method of manufacturing a hydrophobic aerogel comprising
reforming a wet gel into a hydrophobic aerogel by a known normal temperature and pressure method:
directly providing a reticular basket in a reactor;
introducing a wet gel into the basket;
providing an ultrasonic generator under the reactor to emit ultrasonic waves; and
providing a nitrogen injection unit under the ultrasonic generator to inject nitrogen into the reactor upwards, thereby accelerating a reaction.

2. An apparatus for manufacturing a hydrophobic aerogel comprising:
a reactor for reforming a wet gel into a hydrophobic gel, the reactor being provided therein with a support to allow a basket to be disposed therein,
an ultrasonic generator which is provided under the reactor; and
a nitrogen injection unit which is provided under the ultrasonic generator.

3. The apparatus for manufacturing a hydrophobic aerogel according to claim 2, wherein the ultrasonic generator is embedded in a compartment formed by a partition wall provided at a lower portion of a body of the reactor.
